(19) United States
(12) Patent Application Publication
(10) Pub. No.: US 2014/0176037 A1
(43) Pub. Date: Jun. 26, 2014

(54) CONTROL UNIT OF ACTUATOR

(71) Applicant: Canon Kabushiki Kaisha, Tokyo (JP)

(72) Inventor: Junki Yoshimuta, Utsunomiya-shi (JP)

(73) Assignee: CANON KABUSHIKI KAISHA, Tokyo (JP)

(21) Appl. No.: 14/108,660

(22) Filed: Dec. 17, 2013

(30) Foreign Application Priority Data
Dec. 20, 2012 (JP) 2012-277584

(51) Int. Cl. G05B 1/03

(52) U.S. Cl. CPC G05B 1/03
USPC 318/632

(57) ABSTRACT

A control unit is configured to control driving of an actuator using an output of a rotary encoder having a rotator with a pattern row. The control unit includes a memory configured to store correcting information used to correct an arrangement error of the pattern row, and a controller configured to correct an output of the rotary encoder using the correcting information stored in the memory and to control driving of the actuator based on a corrected output of the rotary encoder.

### BACKGROUND OF THE INVENTION

1. Field of the Invention

The present invention relates to a control unit which controls driving of an actuator.

2. Description of the Related Art

There are various types of actuators, and a closed loop control method using an encoder is generally used to control its control position, velocity, acceleration, or the like. Japanese Patent Laid-Open No. (“JP”) 11-89293 discloses a feedback control unit of a stepping motor capable of correcting uneven rotating velocities on the real-time basis. More specifically, the feedback control unit includes a unit (rotary encoder) configured to monitor a rotating velocity of the stepping motor, a unit configured to generate a control signal to make the rotating velocity close to a target value, and a unit configured to change the rotating velocity on the real-time basis using the control signal.

However, a new encoder-derived problem occurs, such as an attachment error of a position detector, and a shift of a distance between the encoder and the position detector, as well as uneven encoder pitches and decentering of the encoder in case of the rotary type. These errors and shifts cause the disturbance for the feedback information in the closed loop control, lowering the control precision. In particular, the uneven encoder pitch and decentering in the rotary type result in cyclic errors for each one cycle of the encoder.

### SUMMARY OF THE INVENTION

The present invention provides a control unit configured to precisely control driving of an actuator.

A control unit according to the present invention is configured to control driving of an actuator using an output of a rotary encoder having a rotator with a pattern row. The control unit includes a memory configured to store correcting information used to correct an arrangement error of the pattern row, and a controller configured to correct an output of the rotary encoder using the correcting information stored in the memory and to control driving of the actuator based on a corrected output of the rotary encoder.

Further features of the present invention will become apparent from the following description of exemplary embodiments with reference to the attached drawings.

### BRIEF DESCRIPTION OF THE DRAWINGS

FIG. 1 is a block diagram of an image-pickup apparatus according to this embodiment.

FIG. 2 is a perspective view of a focus motor unit applicable to FIG. 1.

FIG. 3 is a block diagram of a driving system of an actuator illustrated in FIG. 1.

FIG. 4 is a diagram of a sine wave table stored in a sine wave signal generator illustrated in FIG. 3.

FIG. 5 is a diagram for explaining a relationship between the sine wave generator and an encoder output signal, values in the sine wave table obtained from this relationship, and calculated correcting information according to this embodiment of the present invention.

FIG. 6 is a diagram for explaining calculation of correcting information according to this embodiment of the present invention.

FIG. 7A is a schematic plane view of a sensor magnet having ten poles magnetized ideally at regular intervals and a Hall IC, and FIG. 7B is a diagram illustrating an output signal waveform of the Hall IC when the sensor magnet rotates at a constant velocity.

FIG. 8A is a schematic plane view of a sensor magnet having magnetic pole intervals according to this present embodiment and a Hall IC, and FIG. 8B is a diagram illustrating an output signal waveform of the Hall IC when the sensor magnet rotates at a constant velocity.

FIG. 9 is a flowchart of processing in a reset operation according to this present embodiment.

FIG. 10 is a flowchart illustrating processing in a focus driving instruction according to this embodiment.

### DESCRIPTION OF THE EMBODIMENTS

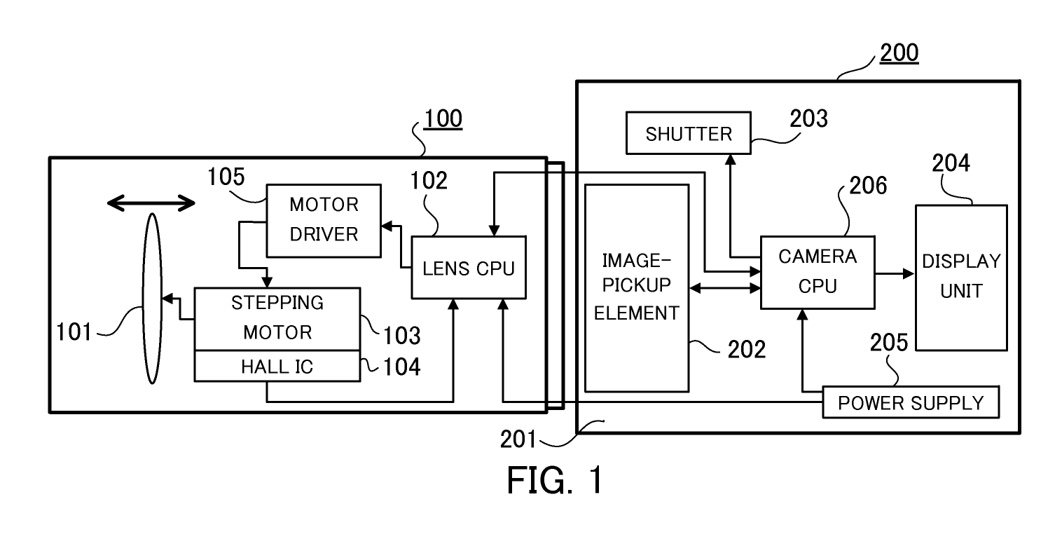

FIG. 1 is a block diagram of an image-pickup apparatus (optical apparatus) according to this embodiment. Now, the image-pickup apparatus illustrated in FIG. 1 is a single-lens reflex digital camera including an interchangeable lens 100 having a stepping motor 103, which is an illustrative actuator, in a focus unit, and a camera body 200. The interchangeable lens 100 can be freely attached to and detached from the camera body 200 via a mount 201 provided on the camera body 200.

The image-pickup apparatus may be a digital still camera or a digital video camera. The interchangeable lens (lens unit) may be integral with the camera body. The image-pickup apparatus is not restricted to a single-lens reflex camera, but may be a mirror-less camera, a microscope, or the like. The actuator is not limited to a stepping motor, and may be applied to other devices such as a printer, a scanner, and a copy device.

When the interchangeable lens 100 is attached to the camera body 200, a lens CPU 102 in the interchangeable lens 100 and a camera CPU 206 in the camera body 200 are connected to each other so that they can communicate with each other. As a result, the lens CPU 102 operates under control of the camera CPU 206.

A description will now be given of configurations of the interchangeable lens 100 and the camera body 200 relating to the present invention.

The interchangeable lens 100 includes a focus lens 101, the lens CPU 102, the stepping motor 103, a Hall IC 104 and a motor driver 105.

The focus lens (optical element, driven member) 101 is included in an image-pickup optical system that condenses a luminous flux from an object (not illustrated) and forms an optical image. The focus lens 101 adjusts a focus position of the image-pickup optical system when it is moved in an arrow direction (optical axis direction) illustrated in FIG. 1. While FIG. 1 simply illustrates the focus lens 101 as one lens, the focus lens 101 may be a lens unit having a plurality of lenses.

The stepping motor 103 is an actuator configured to rotate by every predetermined step angle in accordance with a pulsed current which is input from the motor driver 105 every step, and is attached to a movable unit configured to drive the focus lens 101. The focus lens 101 can be moved in the optical axis direction by driving the stepping motor 103. Assume that the stepping motor 103 is a two-phase, ten-pole motor in this embodiment.

The Hall IC 104 is a detector in a rotary encoder which detects a rotation state of the stepping motor 103. Details of the encoder will be described later.

The motor driver 105 receives a driving order instruction from the lens CPU 102, and applies a pulse current to the stepping motor 103 for each step so as to drive the focus lens 101.

The lens CPU 102 is a controller which receives a focus lens driving instruction such as a target position, and a driving velocity from the camera CPU 206, sends an output to the motor driver 105, and drives the stepping motor 103. The lens CPU 102 is a microcomputer. The lens CPU 102 obtains feedback information of the stepping motor 103 from an output signal of the Hall IC 104, and exercises closed loop control over the focus lens 101 so that the stepping motor 103 obeys the driving instruction.

The camera body 200 includes an image-pickup element 202, a shutter 203, a display unit 204, a power supply 205, and the camera CPU 206.

The image-pickup element 202 includes a light receiving surface in which photoelectric conversion elements are arranged, provides a photoelectric conversion to an optical image of the object (not illustrated) formed on the light receiving surface by the image-pickup optical system, converts a resultant signal to a digital signal, and outputs the digital signal to the camera CPU 206.

The shutter 203 is disposed for the light receiving surface of the image-pickup element 202, and brings the light receiving surface of the image-pickup element 202 into an exposure state or light-shielding state in accordance with an instruction from the camera CPU 206. It is possible to control the exposure dose in the image-pickup element 202 by controlling the exposure time period for the light receiving surface of the image-pickup element 202.

The display unit 204 is provided, for example, on the back of the camera body 200. The display unit 204 displays image data obtained via the image-pickup element 202 and various kinds of information for the image data under control of the camera CPU 206.

The power supply 205 supplies power to the camera CPU 206 in the camera body 200, and the lens CPU 102 or the like when the interchangeable lens 100 is attached.

The camera CPU 206 is a controller configured to control various types of operations in the camera body 200. The camera CPU 206 is a microcomputer. The camera CPU 206 also conducts various types of processing including image processing on a digital signal obtained from the image-pickup element 202. At necessary time to drive the focus lens 101 such as in the autofocus (AF), the camera CPU 206 outputs a driving instruction including a target position and a driving velocity of the focus lens 101 to the lens CPU 102.

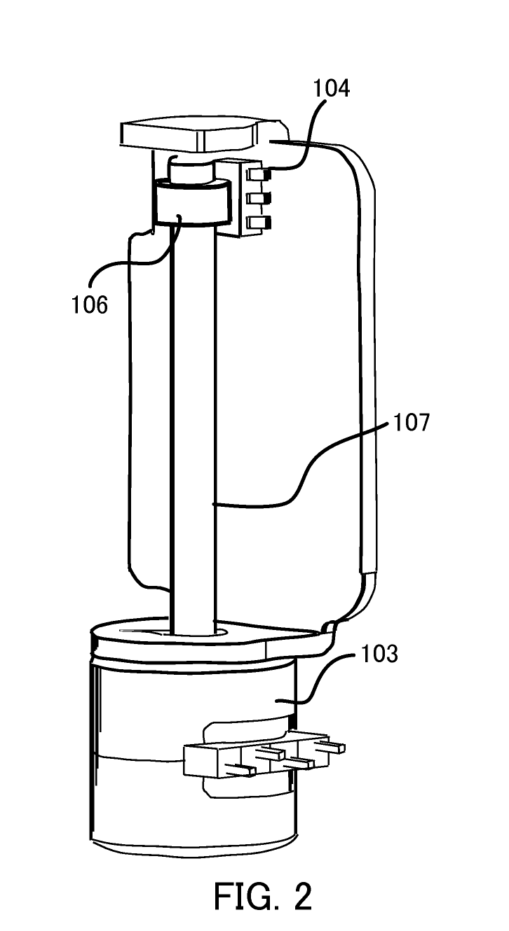

FIG. 2 is a perspective view of a focus motor unit according to this embodiment. The focus motor unit includes the stepping motor 103, the Hall IC 104, a sensor magnet 106, and a rotating shaft 107. The Hall IC 104 and the sensor magnet 106 constitute a rotary encoder.

The sensor magnet 106 is a rotator attached to the rotating shaft 107 and having a pattern row corresponding to a rotating position. The shape of the rotator is, for example, but not limited to, a disk. According to this embodiment, the pattern row is a magnetic pattern row, and the sensor magnet is magnetized with ten poles of the same number as magnetic poles of the stepping motor 103. The Hall IC 104 magnetically detects the magnetic pattern row. In other words, according to this embodiment, the Hall IC 104 is attached to a mechanically designed position, the rotating shaft 107 rotates as the rotor of the stepping motor 103 rotates, and the sensor magnet 106 on a shaft of the rotating shaft 107 also rotates. The magnetic flux density received by the Hall IC 104 changes as the sensor magnet 106 rotates in the vicinity to the Hall IC 104, and an output signal of the Hall IC 104 changes. The Hall IC 104 outputs two types of alternate detection signals from one IC.

The detector is not limited to the Hall IC, but a plurality of Hall elements may be disposed to detect the alternate magnetic field. The pattern row includes of a plurality of light transmitting slits, and the detector includes a light emitting element and a light sensing element and optically detects the pattern row depending upon whether the optical path is shielded.

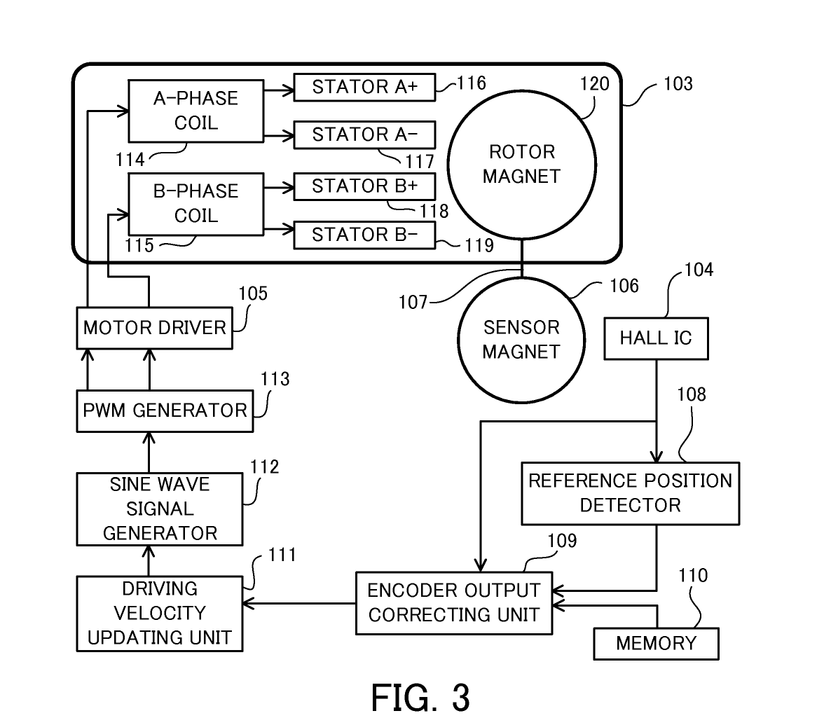

FIG. 3 is a block diagram of a driving system including an electric circuit configured to drive the focus lens 101. Components other than the stepping motor 103 can serve as a control unit configured to control driving of the stepping motor 103. A reference position detector 108, an encoder output correcting unit 109, a driving velocity updating unit 111, and a sine wave signal generator 112 may be a part of the lens CPU 102 as a controller.

As the stepping motor 103 rotates, the magnetic flux density received by the Hall IC 104 changes and the output signal of the Hall IC 104 changes. The output signal of the Hall IC 104 is input to the reference position detector 108 and the encoder output correcting unit 109. The output signal of the Hall IC 104 will be referred to as “encoder output signal” hereinafter. The encoder output signal is a pulsed signal. Feedback processing is executed at toggle timing, i.e., at timing when the alternate magnetic field of the sensor magnet 106 received by the Hall IC 104 switches.

The reference position detector 108 determines whether the encoder output signal corresponds to the reference position, i.e., whether the alternate magnetic field of the sensor magnet 106 detected by the Hall IC 104 corresponds to a reference magnetic pole. In other words, the reference position detector 108 detects a reference position in the output of the Hall IC 104. When the encoder output signal corresponds to the reference position, the reference position detector 108 outputs a reference position notifying signal, which indicates that the current encoder output signal corresponds to an encoder output signal from a magnetic pole at the reference position, to the encoder output correcting unit 109. The reference position detector 108 outputs the reference position notifying signal for each rotation of the sensor magnet 106 or the rotor of the stepping motor 103.

The encoder output correcting unit 109 acquires the encoder output signal from the Hall IC 104 and the reference position notifying signal from the reference position detector 108. The encoder output correcting unit 109 determines the driving direction in response to an instruction from the lens CPU 102, and calculates the magnetic pole position of the sensor magnet 106 relatively from the acquired reference position notifying signal or the last reference position notifying signal. This processing determines the magnetic pole position of the sensor magnet 106 corresponding to the current encoder output signal.

The encoder output correcting unit 109 reads out corresponding correcting information from a memory 110 in order to correct an error contained in the magnetic pole of the sensor magnet 106, and corrects values in the sine wave table of the micro-step driving waveform. The “error contained in the magnetic pole” means a shift amount from 36° when the two-phase, ten-pole stepping motor 103 is ideally magnetized at regular intervals of 36° per pole.

In particular, the encoder output correcting unit 109 acquires correcting information corresponding to the reference position from the memory 110 when the reference position detector 108 has detected the reference position corresponding to a specific rotating position, and corrects the output of the Hall IC 104. In other words, the encoder output correcting unit 109 corrects the output of the Hall IC 104 using correcting information stored in the memory (storage unit) 110. The encoder output correcting unit 109 associates the output of the Hall IC 104 with correcting information by setting the specific rotating position to the reference position. The reference position corresponds to an acyclic pattern which will be described later.

Without using the reference position, the output of the Hall IC 104 and the correcting information can be associated with each other if they have similar characteristics. In this case, the lens CPU 102 associates them with each other through matching that maximizes the similarity between data row of the output of the Hall IC 104 and the data row of the correcting information.

When the last magnetic pole of the sensor magnet 106 stored by the encoder output correcting unit 109 shifts from a magnetic pole of the sensor magnet 106 detected by the Hall IC 104 due to the chattering or outrageous disturbance, an erroneous correction may occur. However, the reference position detector 108 cyclically detects the reference position, and thus the redetection is available with a high resolution within one rotation of the rotor of the stepping motor 103 and the reference position can be corrected and restored.

The memory 110 is a storage unit configured to store correcting information used to correct an arrangement error of the pattern row contained in the sensor magnet 106 as an encoder. The “correcting information” is a value in a sine wave table of the micro-step driving waveform, and is information acquired by detecting an output of the rotary encoder when the stepping motor 103 is controlled to rotate at a constant velocity. The sine wave table will be described in detail later in the description of the sine wave signal generator 112. The lens CPU 102 controls driving of the stepping motor 103 based on the output of the rotary encoder by using the correcting information stored in the memory 110.

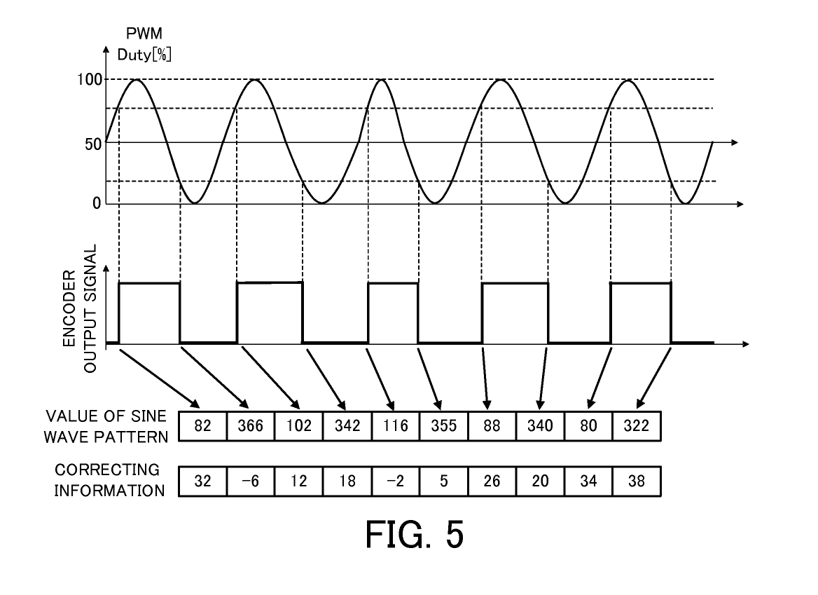

The stepping motor 103 is previously driven at a constant velocity in the open loop control, and a value of the sine wave table when the encoder output signal has toggled is acquired as illustrated in FIG. 5. FIG. 5 illustrates, in order from the top to the bottom, a micro-step driving waveform applied to the stepping motor 103, the encoder output signal, a value of a sine wave pattern obtained at the toggle timing of the encoder output signal, and a data row of correcting information calculated from the value of the sine wave pattern. The abscissa axis of the micro-step driving waveform is time, and the ordinate axis thereof is a duty ratio of the PWM output. The abscissa axis of the encoder output signal is time, and the ordinate axis is the output of the Hall IC 104.

The sine wave table has a resolution of 512 per one cycle. A pulse interval between two adjacent magnetic poles of the same phase of the sensor magnet 106 ideally has a width of 256, and a pulse interval between two magnetic poles of the same pole and different phases ideally has a width of 128. A shift from this ideal width is an error contained in the magnetic pole of the sensor magnet 106, and correcting information used to correct this error is stored in the memory 110.

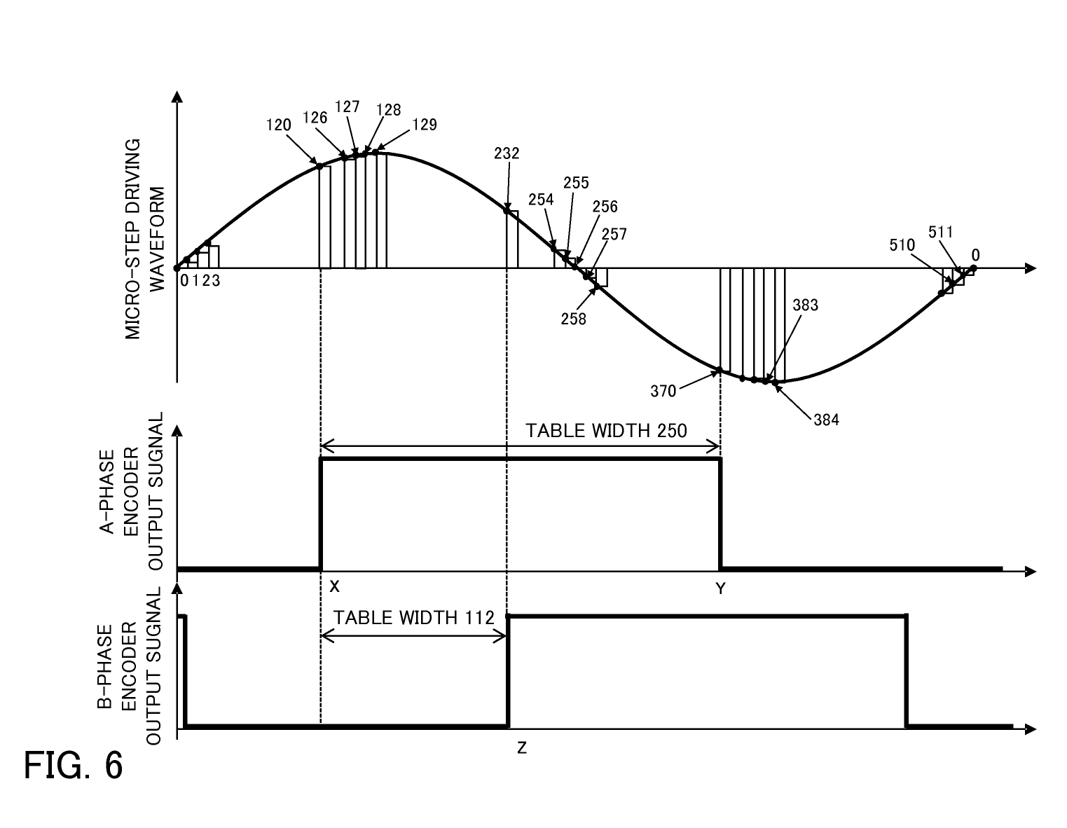

FIG. 6 illustrates a concrete example. The abscissa axis indicates time. FIG. 6 illustrates a micro-step driving waveform applied to the stepping motor 103 that is driven at the constant velocity and the encoder output signal waveforms. In the waveforms, The top ordinate axis is the micro-step driving waveform output from the sine wave signal generator 112, the middle ordinate axis is an encoder output signal waveform of an A phase output from the Hall IC 104, and the bottom ordinate axis indicates an output signal waveform of a B phase.

A pulse interval between two adjacent magnetic poles of the same phase of the sensor magnet 106 is represented by a time point X and a time point Y in the A-phase encoder output signal waveform. A value of the sine wave table corresponding to the time point X is 120, and a value of the sine wave table corresponding to the time point Y is 370. The table width is 370−120=250. Since the ideal table width is 256, a deficiency of 6 corresponds to a magnetizing shift amount.

Similarly, for the pulse interval between two magnetic poles of the different phase and the same pole, a difference between a table width between the time point X and a time point Z and the ideal table width 128 corresponds to the magnetizing shift. The memory 110 stores a surplus or deficiency of the value of the sine wave table at each magnetic pole, and whenever the encoder output signal of a corresponding magnetic pole is obtained, the encoder output signal is supplemented by the table value held in the memory 110. This system reduces the error contained in the magnetic pole of the sensor magnet 106. The data row in the correcting information held by the memory 110 is acquired in the reset operation. The reset operation will be described later.

The driving velocity updating unit 111 provides feedback control over the driving velocity of the stepping motor 103 based on a difference between an actual driving velocity of the stepping motor 103 obtained from the Hall IC 104 and the driving velocity instructed by the camera CPU 206. The driving velocity updating unit 111 calculates the driving velocity of the stepping motor 103 based upon the output of the encoder output correcting unit 109, and adjusts the driving velocity if there is a difference from the target velocity supplied from the camera CPU 206. The velocity adjusting degree depends upon the difference value and a distance to the target position.

The sine wave signal generator 112 has table values of resolution of 512 for one cycle of a sine wave, and outputs a PWM value corresponding to the table value to a PWM generator 113. The sine wave signal generator 112 stores a duty ratio of the PWM in each of 512 tables.

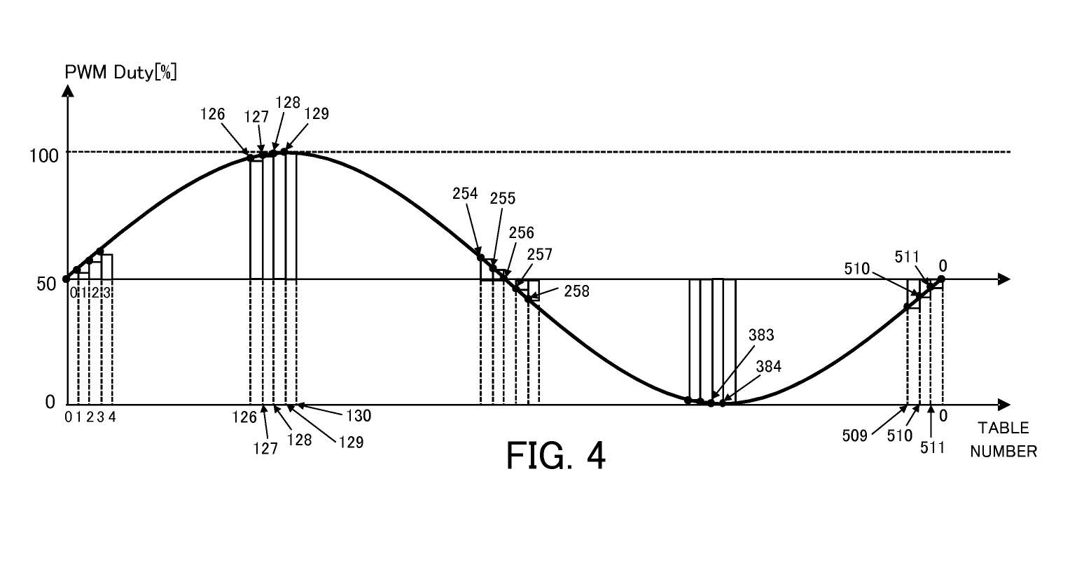

FIG. 4 illustrates details of the sine wave table. The abscissa axis indicates a table number, and the ordinate axis indicates a duty ratio of the PWM output. Table 0 corresponds to the 0° phase of the sine wave, and table 128 corresponds to the 90° phase of the sine wave. A value of 50% is stored in the table 0, and a value of 100% is stored in the table 128. A value of the duty ratio of the PWM output is stored in each table according to the phase.

The PWM generator 113 converts the PWM value given by the sine wave signal generator 112 into a PWM signal, and outputs the PWM signal to the motor driver 105. Thus, the driving velocity updating unit 111 to the PWM generator 113 exercises driving control over the stepping motor 103 based on the corrected information.

The motor driver 105 amplifies the PWM signal and outputs the resultant signal to the stepping motor 103. An A-phase coil 114 and a B-phase coil 115 receive the PWM signal issued from the motor driver and cause a stator A+ 116, a stator A− 117, a stator B+ 118, and a stator B− 119 in a subsequent stage to generate four types of sine wave voltages having different phases.

A rotor magnet 120 is configured to freely rotate, and stators are disposed around the rotor magnet 120 for each physical angle of 18°. The stator A+ 116 and the stator B+ 118 generate the N-pole magnetic force when a voltage applied to the coil is in a positive area of the sine waveform. The stator A− 117 and the stator B− 119 generate the S-pole magnetic force when a voltage applied to the coil is in a positive area of the sine waveform. Outputs of the A-phase and the B-phase have a phase difference of 90° in order to rotate the rotor magnet 120. In the normal rotation, the waveforms are output in which the B phase is faster by 90°. In the reverse rotation, waveforms are output in which the A phase is faster by 90°.

The configuration of the driving system configured to drive the focus lens 101 has been thus described. The closed loop control is implemented by using the Hall IC 104 and the sensor magnet 106 in the rotary encoder. A description will be given of a detector of a reference position of an encoder necessary to correct an error contained in the encoder.

The correcting information stored in the memory 110 has numerical value data of 20 for two phases for the short-distance driving/infinity driving. Once a relationship between the magnetic pole position of the encoder for one phase and correcting information for one phase is determined based upon the driving direction of the stepping motor 103, the relationships for the other phase and the reverse direction driving are also determined. One solution to uniquely determining the relationship between the magnetic pole position of the encoder and the correcting information is a matching method between a data row of the correcting information and a data row of a value of a sine wave table obtained during driving. Since the correcting information to be stored in the memory 110 is acquired in the following reset operation, the correcting information differs according to the individual sensor magnet 106. When the magnetization of the sensor magnet 106 has a characteristic portion or an acyclic pattern, the correcting information also comes to possess a characteristic data row and consequently the positional relationship in the matching means can be precisely determined. On the contrary, when the magnetization of the sensor magnet 106 has no characteristic portion, it is difficult to guarantee the positional relationship. This embodiment intentionally provides the sensor magnet 106 with an acyclic pattern in the magnetization so as to facilitate matching processing.

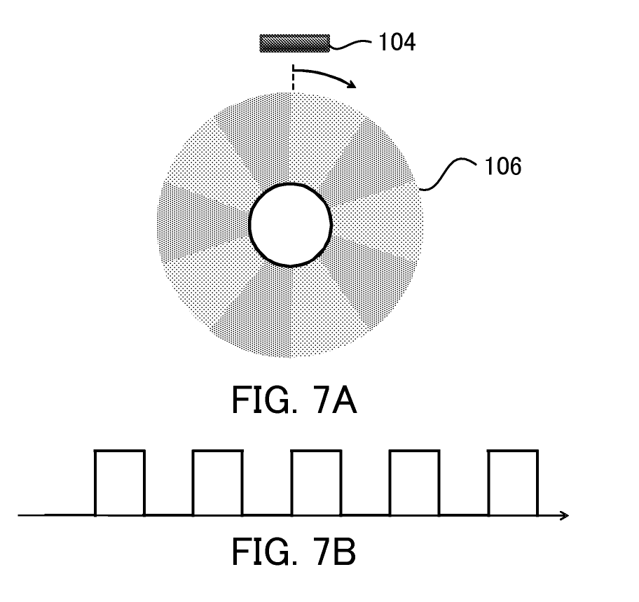

FIG. 7A is a schematic plane view of the sensor magnet 106 with ten poles ideally magnetized at regular intervals and the Hall IC 104. FIG. 7B illustrates an output signal waveform of the Hall IC 104 when the sensor magnet 106 illustrated in FIG. 7A rotates at a constant velocity in the arrow direction (clockwise). The output of the Hall IC 104 changes between the high level and the low level when the magnetic field of the S pole and the magnetic field of the N pole alternate. More specifically, as the S pole of the sensor magnet 106 approaches to the Hall IC 104 and the magnetic flux density exceeds a predefined value, the output signal of the Hall IC 104 changes from the high level to the low level. On the contrary, as the N pole of the sensor magnet 106 approaches to the Hall IC 104 and the magnetic flux density falls to a predefined value, the output signal of the Hall IC 104 changes from the low level to the high level.

In the constant velocity driving when the magnetic pole interval of the sensor magnet 106 is ideally uniform as illustrated in FIG. 7A, the output signal of the Hall IC 104 becomes a regular interval pulse output as illustrated in FIG. 7B. However, due to the errors contained more or less in the magnetic pole interval of the sensor magnet 106 in the manufacture process, the regular interval waveform illustrated in FIG. 7B is not obtained.

The feedback with the erroneously magnetizing intervals false recognizes that the driving velocity of the stepping motor 103 varies. The constant velocity driving cannot achieve the steady state or highly sensitive driving control.

This embodiment reduces such manufacture errors contained in the encoder, using software. The value handled in the velocity control is a value in the sine wave table in the micro-step driving as soon as the output signal waveform of the Hall IC 104 has toggled. Therefore, an error amount is calculated from the value from a sine wave table in the micro-step driving at the timing when the output signal of the Hall IC 104 toggles, and stored as correcting information in the memory 110. As described above, the ideal magnetic pole interval is a phase difference of sine wave 180° for adjacent poles of the same phase, and the ideal magnetic pole interval is a phase difference of sine wave 90° for the same pole and different phases. Thus, the error amount can be calculated based upon this relationship and the actual output signal waveform of the Hall IC 104.

Thus, the correcting information can be obtained by measuring an error included in the magnetic pole of the sensor magnet 106, but it is necessary to always monitor the correcting information and the corresponding magnetic poles of the sensor magnet 106.

One conceivable, illustrative monitoring unit is a marker disposed in an arbitrary position of the sensor. A reference position can be recognized by disposing and detecting the marker, but the marker as a new component is not suitable due to a cost increase, more attachment error factors, and the like. Furthermore, as described above, the reliability of the reference position cannot be ensured unless the sensor magnet 106 has a characteristically magnetized in the marker-less matching unit. This embodiment therefore sets the reference position by adjusting an arbitrary magnetic pole interval of the sensor magnet 106 without requiring a new member.

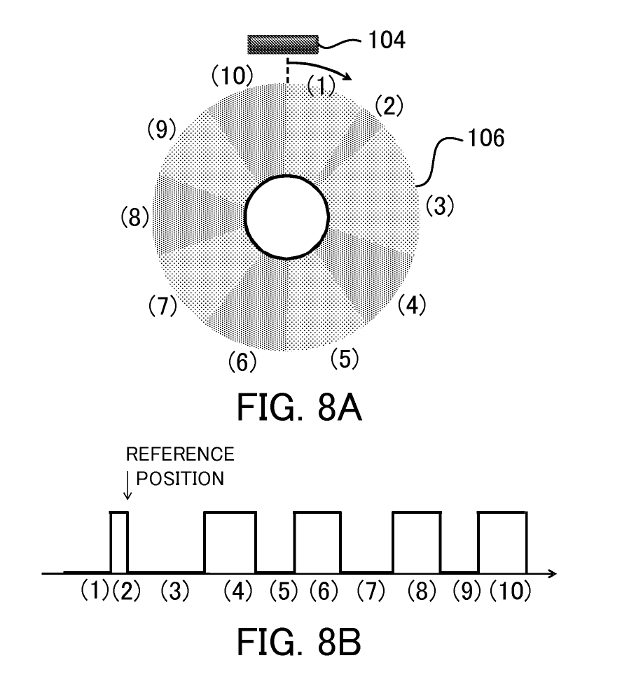

FIG. 8A is a schematic plane view of the sensor magnet 106 and the Hall IC 104 according to this embodiment. Respective ten magnetic poles of the sensor magnet 106 are represented by (1) to (10). In the sensor magnet 106, N poles and S poles are alternately magnetized. According to this embodiment, the magnetic pole interval of the magnetic poles (2) and (3) are made not uniform (center angles are made not uniform) and magnetic pole intervals of the magnetic poles (1), (4) to (10) are made to be regular intervals so that the center angle is set to 36° for each pole. FIG. 8B illustrates the output signal waveform from the Hall IC 104 when the sensor magnet 106 illustrated in FIG. 8A rotates at a constant velocity in the illustrated arrow direction (clockwise).

In other words, a position-detecting pattern row of the sensor magnet 106 according to this embodiment includes cyclic patterns (4), (6), (8) and (10) and an acyclic pattern (2). An output from the Hall IC 104 for an acyclic pattern differs from that of an output of the Hall IC 104 in at least one of a pulse width, a cycle, an amplitude, and a duty ratio. This embodiment forms the pattern row by adjusting a magnetic intensity or the magnetic pole interval. The pattern row that includes light transmitting slits may be formed by adjusting a transmitting light quantity or transmitting interval.

In FIG. 8B, (1) to (10) represent magnetic pole positions of the sensor magnet 106 corresponding to the output signal waveform of the Hall IC 104. A toggle interval in the output signal waveform of the Hall IC 104 which corresponds to the magnetic pole (2) whose magnetic pole interval is made narrow is narrower than that of another magnetic pole. On the contrary, a toggle interval in the output signal waveform of the Hall IC 104 which corresponds to the magnetic pole (3) whose magnetic pole interval is made wide is wider than that of another magnetic pole.

Since the toggle intervals of the magnetic poles (2) and (3) are more characteristic than those of other magnetic poles, the toggle intervals of the magnetic poles (2) and (3) can be easily identified by using a threshold. This embodiment sets the magnetic pole (2) having a narrow toggle interval to the reference position. This scheme can solve a problem of confusion with another magnetic pole due to a rapid velocity variation. If the magnetic pole (3) having a wide toggle interval is set to the reference position, it might be confused with the magnetic poles (1), (2) and (4) to (10) when the rapid velocity changes.

For the condition of the magnetic pole interval of the acyclic pattern, a shift amount must larger than a manufacture error of the magnetic pole interval, or the target toggle interval must be narrower than the uniformly magnetized toggle interval which is output at the highest operational velocity, or the like.

While this embodiment detects a reference position from one magnetic pole having an irregular magnetic pole interval, the reference position may be detected based upon the magnitude of the magnetic intensity or a plurality of magnetic pole patterns. The pattern row of the sensor magnet 106 is not limited to the present embodiment. For example, a ten-pole magnet may be magnetized so that one pole is magnetized with 18°, two adjacent poles are magnetized with 45°, and seven remaining poles are magnetized with 36°, or so as to form two narrow poles having acyclic patterns.

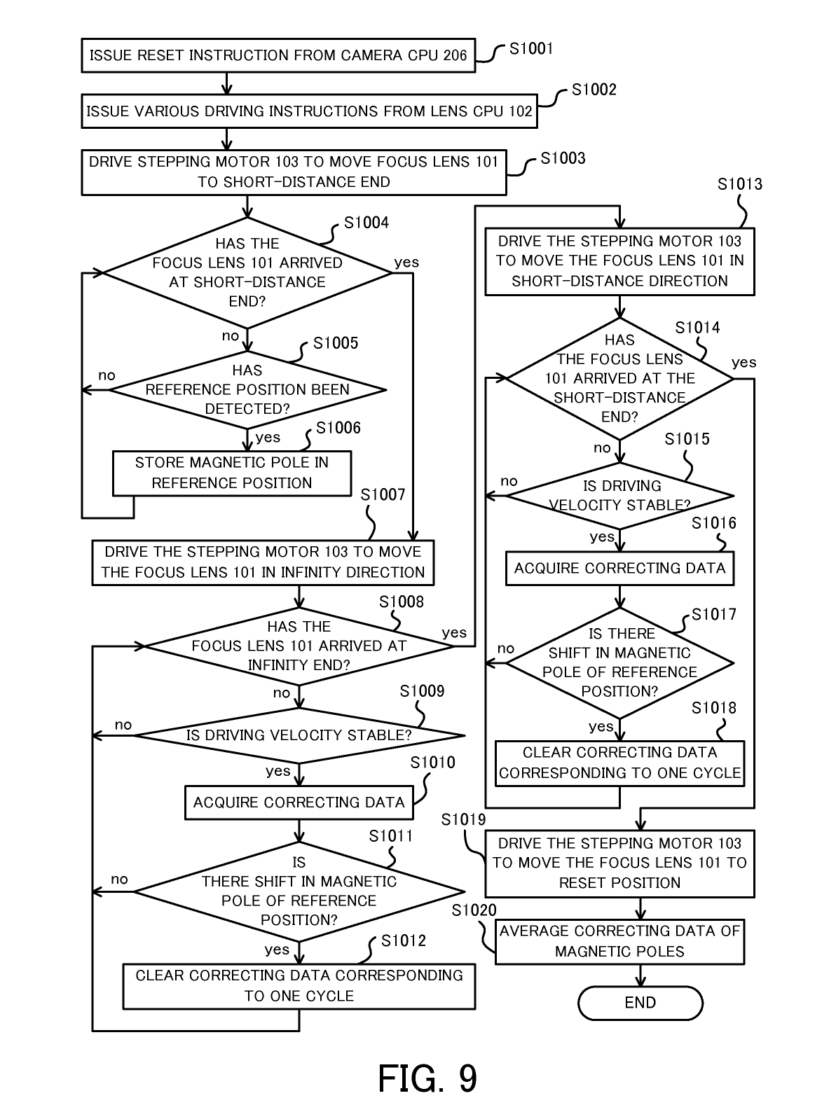

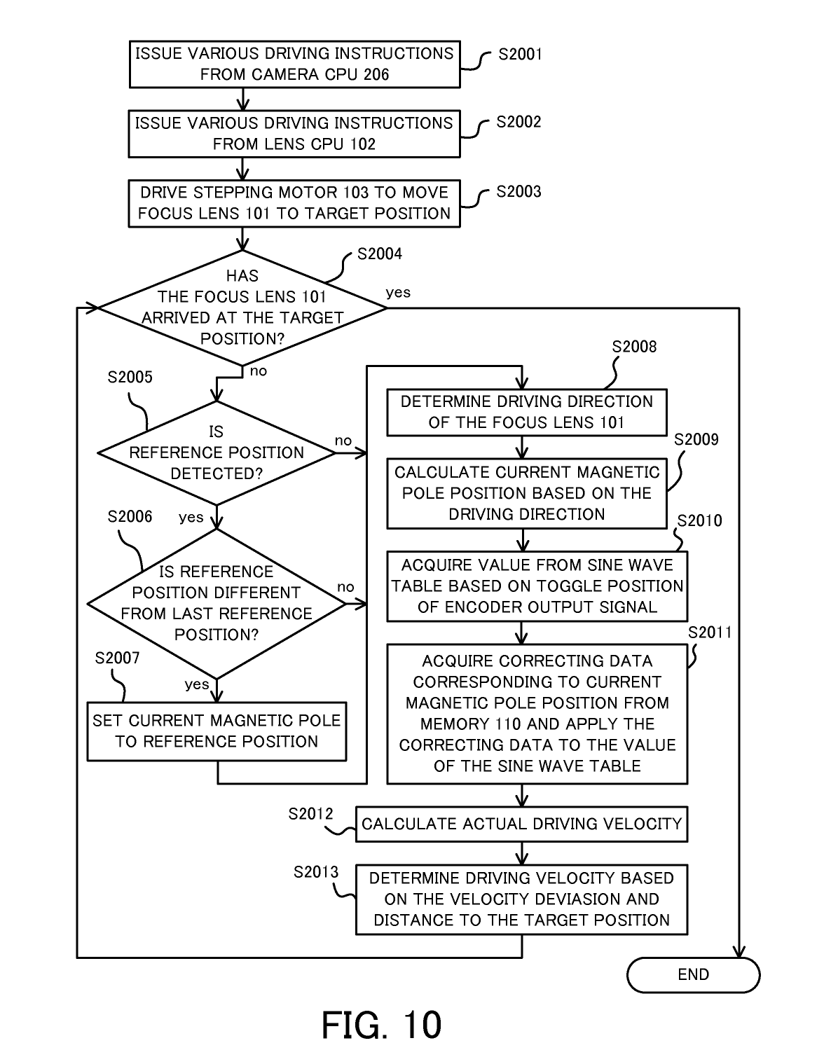

FIG. 9 is a flowchart illustrating acquiring processing of the correcting information in a reset operation of the interchangeable lens 100. In FIG. 9, “S” stands for “step.” The flowchart illustrated in FIG. 9 can be implemented as a program that enables a computer to execute a function of each step. Unless otherwise stated, the step illustrated in FIG. 9 is executed by the lens CPU 102. This is also true of FIG. 10.

If the camera CPU 206 issues a reset instruction in S1001, the interchangeable lens 100 starts the reset operation. In S1002, the lens CPU 102 receives the reset instruction issued by the camera CPU 206 and issues reset operation instructions to a variety of driving systems in the interchangeable lens 100. In S1003, a driving instruction issued by the lens CPU 102 drives the stepping motor 103 at predefined rotating velocity in order to move the focus lens 101 to the short-distance end.

In S1004, the lens CPU 102 determines whether the focus lens 101 has arrived at the short-distance end. If the focus lens 101 has not yet arrived at the short-distance end, the flow proceeds to S1005. In S1005, the lens CPU 102 determines whether the reference position is detected. The reference position detector 108 makes a determination based upon the toggle timing of the encoder output signal output from the Hall IC 104. In response to a pattern representative of the reference position, the flow proceeds to S1006. Otherwise, the flow proceeds to S1004. In S1006, the lens CPU 102 stores a magnetic pole at the detected reference position, and monitors a relative magnetic pole position from this reference position in the subsequent processing so as to recognize a current magnetic pole position.

The lens CPU 102 drives the stepping motor 103, and the flow moves to S1007 when the focus lens 101 arrives at the short-distance end. It is conceivable that the focus lens 101 reaches the short-distance end at the time of S1003 or before the Hall IC 104 detects the magnetic pole as the reference position. Although the magnetic pole of the reference position in S1006 cannot be stored, the reference position can be detected through S1007 and subsequent steps in the flow illustrated in FIG. 9.

In S1007, the lens CPU 102 drives the focus lens 101 located at the short-distance end in the infinity direction at a predetermined rotating velocity using the stepping motor 103. In S1008, the lens CPU 102 determines whether the focus lens 101 has arrived at the infinity end. If the focus lens 101 has not yet arrived at the infinity end, the lens CPU 102 determines in S1009 whether the rotating velocity of the stepping motor 103 is stable. More specifically, the lens CPU 102 calculates the driving velocity based upon a pulse width of the encoder output signal of the Hall IC 104 and determines whether the driving velocity gradually approaches to the velocity set in the driving instruction issued by the lens CPU 102 to the stepping motor 103. This processing is provided because the rotation of the rotor may be unstable just after the operation of the stepping motor 103 starts and accurate correcting information may not be acquired.

If the rotating velocity of the stepping motor 103 is stable, the lens CPU 102 acquires correcting information of the corresponding magnetic pole from the encoder output signal and temporarily stores the correcting information into the memory 110 in S1010. This correcting information stored herein is correcting information when the focus lens 101 is driven in the infinity direction.

After the correcting information is obtained in the driving in the infinity direction, the lens CPU 102 determines in S1011 whether there is a shift of the magnetic pole of the reference position. The reference position detector 108 detects the reference position for each one period of the rotor in the stepping motor 103, and the lens CPU 102 determines whether there is a difference between the detected reference position and the reference position stored in S1006.

Since a difference causes an error in the correcting information acquired in the last one rotor cycle, the lens CPU 102 clears the correcting information for the last one rotor cycle acquired in S1010 from the memory 110 in S1012. At the same time, the lens CPU 102 restores the reference position, and recognizes a current magnetic pole position by always monitoring a relative magnetic pole position from the reference position again. The flow of S1009 to S1012 is repeated until the focus lens 101 reaches the infinity end. When the focus lens 101 reaches the infinity end, the stepping motor 103 stops once and the flow proceeds to S1013.

In S1013, the lens CPU 102 drives the focus lens 101 located at the infinity end in the short-distance direction at a predetermined rotating velocity by using the stepping motor 103. In S1014, the lens CPU 102 determines whether the focus lens 101 has arrived at the short-distance end. If the focus lens 101 has not arrived at the short-distance end, the flow proceeds to S1015.

In S1015, the lens CPU 102 determines whether the rotating velocity of the stepping motor 103 is stable, similar to S1009. If the rotating velocity is stable, flow proceeds to S1016 so as to acquire correcting information when the focus lens 101 is driven in the short-distance direction and to temporarily store the correcting information into the memory 110.

In S1017, the lens CPU 102 determines whether there is a shift of the reference-position magnetic pole. If there is a difference between the reference position detected for each one rotor cycle of the stepping motor 103 and the reference position stored in S1006, the flow proceeds to S1018 so as to clear correcting information for the last one rotor cycle. At the same time, the lens CPU 102 restores the reference position, and recognizes a current position by always monitoring the relative magnetic pole position from the reference position again.

The flow of S1015 to S1018 is repeated until the focus lens 101 arrives at the short-distance end. If the focus lens 101 arrives at the short-distance end, the stepping motor 103 stops once and the lens flow proceeds to S1019.

In S1019, the lens CPU 102 resumes the stepping motor 103 and moves the focus lens 101 to a reset position. Finally, in 51020, the lens CPU 102 averages correcting information acquired in S1010 and S1016, and determines correcting information for the magnetic poles. Since the correcting information is stored for each driving direction and for each magnetic pole, the data number is forty. Since the encoder output signal contains noises, the noises become less influential by acquiring correcting information for each magnetic pole a plurality of times and by acquiring an average value for each magnetic pole.

This embodiment performs averaging in consideration for the wow flutter influence, but the correcting information utilized for the encoder output correcting unit 109 may utilize a median of correcting information acquired a plurality of times in consideration for an outlier or the like. This embodiment adopts a magnetic detecting method and obtains the correcting information in the reset operation in consideration for the temperature characteristic of the sensor magnet 106.

The above reset operation provides correcting information suitable for the encoder output signal during the driving, and the current magnetic pole position of the sensor magnet 106 can be recognized so as to stop the focus lens 101 at the reset position. It is therefore possible to correct the encoder output signal based upon the driving start timing. Referring now to the flowchart of FIG. 10, a detailed description will be given of processing conducted by the interchangeable lens 100 when the camera CPU 206 issues a driving instruction.

First, in S2001, the camera CPU 206 determines various operations in accordance with a user's manipulation, and issues the driving instruction pursuant to the manipulation to the interchangeable lens 100. In S2002, the lens CPU 102 receives the driving instruction from the camera CPU 206, and issues instructions to various driving systems including the focus driving system.

In S2003, the stepping motor 103 is driven based on the driving instruction from the lens CPU 102 to move the focus lens 101 to a target position. In S2004, the lens CPU 102 determines whether the focus lens 101 has arrived at the target position. If the focus lens 101 has not arrived at the target position, the reference position detector 108 determines in S2005 whether the encoder output signal is a signal representative of the reference position.

If the encoder output signal represents the reference position, the lens CPU 102 determines in S2006 whether the current stored reference position matches the detected reference position. If the stored reference position does not match the detected reference position, the lens CPU 102 resets the current magnetic pole to the reference position in S2007.

After S2007, when S2005 is NO (or when the encoder output signal is not the signal representative of the reference-position magnetic pole), or when S2006 is false (or when the current stored reference position matches the detected reference position), the lens CPU 102 determines the driving direction of the focus lens 101 in S2008. The lens CPU 102 finds the rotation direction of the sensor magnet 106 by determining the driving direction of the focus lens 101 on the basis of the driving instruction from the CPU 102.

In S2009, the lens CPU 102 calculates the current magnetic pole position based on this information. In S2010, the lens CPU 102 obtains values in the sine wave table in the micro-step driving at the toggle timing of the encoder output signal. The lens CPU 102 has obtained the values in the current sine wave table and the detected current magnetic pole up to S2010. In S2011, the lens CPU 102 obtains correcting information corresponding to the current magnetic pole position from the memory 110, applies the correcting information to the value of the sine wave table, and acquires a value of corrected sine wave table.

In S2012, the lens CPU 102 calculates the actual driving velocity of the stepping motor 103 based on a time difference between the corrected value of the sine wave table and the last corrected value of the sine wave table. In S2013, the lens CPU 102 calculates a velocity difference based on the calculated actual driving velocity and the driving velocity instructed by the lens CPU 102, and further determines the driving velocity of the stepping motor 103 based on the current position of the focus lens 101 and a distance to the target position instructed by the lens CPU 102. When the distance to the target position is long, the lens CPU 102 adjusts the driving velocity to make zero the velocity difference. As the distance to the target position becomes short, the lens CPU 102 decelerates the stepping motor 103 in order to maintain the stopping precision and aims at the target position. The flow of S2004 to S2013 is repeated until the focus lens 101 arrives at the target position. If the focus lens 101 arrives at the target position, the lens CPU 102 stops the driving of the stepping motor 103.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. While the correcting information is obtained in the reset time, the correcting information may be acquired when power supply is turned on.

The present invention can provide a control unit configured to precisely control driving of an actuator.

The present invention is applicable to actuators in the rotating system such as stepping motors, brushless motors, and induction motors used in digital cameras and digital videos.

This application claims the benefit of Japanese Patent Application No. 2012-277584, filed Dec. 20, 2012 which is hereby incorporated by reference herein in its entirety.

What is claimed is:

1. A control unit configured to control driving of an actuator using an output of a rotary encoder having a rotator with a pattern row, the control unit comprising:
a memory configured to store correcting information used to correct an arrangement error of the pattern row; and
a controller configured to correct an output of the rotary encoder using the correcting information stored in the memory and to control driving of the actuator based on a corrected output of the rotary encoder.

2. The control unit according to claim 1, wherein the correcting information is information acquired by detecting the output of the rotary encoder when the actuator is controlled to drive at a constant velocity.

3. The control unit according to claim 1, wherein the controller associates the output of the rotary encoder with the correcting information to maximize similarity between a data row of the output of the rotary encoder and a data row of the correcting information.

4. The control unit according to claim 1, wherein the pattern row of the rotator includes a cyclic pattern and an acyclic pattern, and
wherein the controller associates the output of the rotary encoder with the correcting information using a specific rotating position corresponding to the acyclic pattern as a reference position.

5. The control unit according to claim 4, wherein the output of the rotary encoder corresponding to the acyclic pattern differs from the output of the rotary encoder corresponding to the cyclic pattern in at least one of a pulse width, a cycle, an amplitude and a duty ratio.

6. The control unit according to claim 1, wherein the correcting information stored in the memory is information acquired when the control unit is reset or powered on.

7. The control unit according to claim 4, wherein the pattern row is a magnetic pattern row, and the acyclic pattern is formed by making different a magnetic intensity or a magnetic pole interval.

8. The control unit according to claim 4, wherein the pattern row includes a plurality of light transmitting slits, and the acyclic pattern is formed by making different a transmitting light quantity or a transmitting interval of the light transmitting slit.

9. The control unit according to claim 1, further comprising the rotary encoder.

10. A device comprising:
an actuator that drives a driven member; and
a control unit configured to control driving of the actuator using an output of a rotary encoder having a rotator with a pattern row, the control unit including a memory configured to store correcting information used to correct an arrangement error of the pattern row, and a controller configured to correct an output of the rotary encoder using the correcting information stored in the memory and to control driving of the actuator based on a corrected output of the rotary encoder.

11. A control method for an actuator configured to control driving of an actuator using an output of a rotary encoder that includes a rotator with a pattern row, the control method comprising the steps of:
acquiring correcting information used to correct an arrangement error of the pattern row;
correcting an output of the rotary encoder using the correcting information; and
controlling driving of the actuator based on a corrected output of the rotary encoder.
